(19) United States
(12) Patent Application Publication
(10) Pub. No.: US 2023/0043520 A1
(43) Pub. Date: Feb. 9, 2023

(54) Personality Attachments for Communicating a Message

(71) Applicant: Belinda Newkirk, Greenville, NC (US)

(72) Inventor: Belinda Newkirk, Greenville, NC (US)

(21) Appl. No.: 17/879,824

(22) Filed: Aug. 3, 2022

Related U.S. Application Data
(60) Provisional application No. 63/228,801, filed on Aug. 3, 2021.

(51) Int. Cl. A41D 27/08; A41D 13/11; A62B 23/02

(52) U.S. Cl. CPC A41D 27/08; A41D 13/1161; A62B 23/025

(57) ABSTRACT

The present invention relates to customized personality attachment devices that are configured to display customizable images, words, or phrases to non-verbally convey messages, feelings, or an individual's state of mind. The attachment devices have one surface having a message or image and an opposite surface having an adhesive, hook/loop, or magnetic layer enabling the attachment device to removably attach to one or more of at least face masks, earrings/rings, canisters/cups, shirts, hats/caps, walls, refrigerators, office/school boards, garages, and surfaces such as, but not limited to, helmets, shoes, purses, backpacks, car seats, head rests, the side of vehicles, clothes, customizable identifiers and so much more. The devices are washable and, depending upon placement of the devise, can be made from various types of material including photoluminescent, cotton, vinyl, polyester, polyethylene, polycarbonate, felt, twill, nylon, a variety of other plastics and materials.

### CROSS-REFERENCE TO RELATED APPLICATION

The present application claims priority to, and the benefit of, U.S. Provisional Application No. 63/228,801, which was filed on Aug. 3, 2021 and is incorporated herein by reference in its entirety.

### FIELD OF THE INVENTION

The present invention relates generally to the field of designer decals or stickers and attachments. More specifically, the present invention relates to a novel personality attachment device that is configured to removably or interchangeably attach to a variety of surfaces. The personality attachment comes in an endless array of interchangeable designs made up of various colors, shapes, and sizes to accommodate dynamic thoughts and feelings for enabling individuals to express themselves artistically and communicate non-verbally. The attachment displays customizable images, words, or phrases to convey whatever message a user wishes. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals are social creatures. Individuals like to express their emotions, feelings, and/or state of mind. Extroverted individuals are generally talkative, sociable, action-oriented, enthusiastic, friendly, and out-going and tend to express their feelings by talking to other individuals. Introverted individuals on the other hand tend to focus more on internal thoughts, feelings, and moods and are considered quiet. Introverts talk less and could benefit from a new way to easily translate their feelings and state of mind. Personality is a complex concept that can be formed by a lot of different things. It can be influenced by the environment, our behavior, social attitudes, what we believe in, and others things. Most often personalities are constant and we can predict what a person would like or how they would react to unknown things or situations through their personal expressions. People love having options, this device provides an opportunity for them to express who they are without speaking.

Many individuals have sensory processing disorders, developmental disabilities, social anxiety disorders, and more. Such individuals find it difficult to effectively channel their emotions and express themselves in a healthy way. They find it difficult to express what they want to say or how to say things. Difficulty in translating thoughts or feelings into words can lead to severe stress and mental exhaustion, leaving individuals feeling overlooked and misunderstood. Also, in the lives of everyday people their thoughts and feelings can easily become misinterpreted and inhibited from the day-to-day hustle and bustle. Having an outlet that is adaptive according to your state of mind can help facilitate relief, openness, and freedom from misunderstandings.

During the COVID-19 pandemic, and in general, individuals wear facemasks, and accordingly, it is very difficult to interpret or know the feelings and emotions of individuals without visible and discernible facial cues and expressions. This leads to awkward interactions and communication; therefore, it is desirable to have a method that can help in understanding the thoughts, feelings, and state of mind of a person wearing a facemask.

Many individuals desire to display their beliefs and ideas and use tattoos as a means of displaying them. However, tattoos are permanent, and further, ideas and beliefs also get changed as we grow older and gain experiences. Therefore, it would be better to have a temporary means for displaying thoughts, beliefs, and ideas that are interchangeable according to your personality which is dynamic in nature as well.

Therefore, there exists a long-felt need in the art for a device and method that enables an individual to easily communicate a message, feeling, or state of mind. There is also a long-felt need in the art for a device that enables individuals to display their beliefs and ideas. Additionally, there is a long-felt need in the art for a device that enables individuals to communicate a message non-verbally. Moreover, there is a long-felt need in the art for a device and method that can be used by introverts, extroverts, shy individuals, individuals with developmental disabilities, and more, to share their thoughts effectively. Further, there is a long-felt need in the art for an attachment device that is customizable, brings about self-awareness, and reveals an individual's essence. Finally, there is a long-felt need in the art for attachment devices that can be adhered to any surface and changed at any time enabling individuals to display and communicate new ideas, beliefs, thoughts, messages, feelings, and more without ever having to speak.

The subject matter disclosed and claimed herein, in one embodiment thereof, comprises a customizable personality attachment device. The attachment device is configured to attach to a surface to display and convey a message and further comprises a designer front surface having a customized message printed thereon, a rear surface having an adhesive layer, and the adhesive layer configures the attachment to removably attach to the surface. The attachment device is made of a washable material and helps in translating messages, feelings, or an individual's state of mind without ever having to speak to other individuals.

In this manner, the personality attachment device of the present invention accomplishes all of the forgoing objectives and provides users with a customizable attachment that reveals an individual's essence. The attachment device comes in an endless array of interchangeable designs to accommodate dynamic thoughts, beliefs, and feelings. A message printed on the attachment device enables individuals to express themselves artistically and also affords shy or disabled individuals a way to communicate non-verbally.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a customizable personality attachment device made up of various colors, shapes, and sizes. The attachment device is configured to attach to a surface and further comprises a designer front surface having a customized message printed thereon, a rear surface having an adhesive layer, and the adhesive layer configuring the attachment to removably attach to the surface. The attachment device is made of a washable material and helps in translating a message, a feeling, and/or an individual's state of mind.

In yet another embodiment, a customized facemask attachment device is disclosed. The customized facemask attachment device has a conventional facemask shape without ear loops, a front surface having a customized message indicating a thought, feeling, or a state of mind of a wearer of the mask, a rear surface having a plurality of strips of hook and loop fasteners, the hook and loop fasteners are used for releasably adhering the attachment device to an outer surface of the facemask such that the customized message is easily viewable from outside when the facemask is worn by a user wherein the attachment device is configured to be replaceable with other attachment devices having different customized messages for indicating other messages, feelings, or states of mind.

In yet another embodiment, a customized facemask is disclosed. The customized facemask is designed to protect a wearer of the facemask from pathogens while providing a way to communicate non-verbally. The facemask comprises a pair of ear loops connected to a facemask body, the facemask body designed to cover the mouth and nose of a wearer, and a customized attachment releasably attached to an outer surface of the facemask body wherein the customized attachment has a message printed thereon to communicate non-verbally to other users. The facemask also has a PM2.5 filter for blocking pathogens.

In yet another embodiment, a method of communicating a message non-verbally by a user using a personal attachment decal is described. The personal attachment decal has a first air filtration layer having a customized message printed thereon, an opposite layer having an adhesive surface or a magnetic surface, and the decal is removably attached to an item using the opposite layer such that the message is visible and is used for communicating non-verbally to individuals.

In yet another embodiment, the personal attachment decal can be adhered to at least one of many surfaces such as; ace masks, earrings/rings, canisters/cups, helmets, shirts, hats/caps, shoes, walls, refrigerators, office/school boards, purse, backpack, garages, car seats, headrest, the side of vehicles, clothes, customizable identifiers and much more.

In yet another embodiment, the decal is made of a photoluminescent material.

In yet another embodiment, the decal is made of an electroluminescent material.

In yet another embodiment, the message has a 2D or 3D print.

In yet another embodiment, the attachment is made from one of cloth, plastic, or patch material. various types of material however not limited to; photoluminescent, cotton, vinyl, polyester, polyethylene, polycarbonate, felt, twill, nylon, and a variety of other plastics and materials.

Numerous benefits and advantages of this invention will become apparent to those skilled in the art to which it pertains upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a facemask equipped with a facemask personality attachment of the present invention in accordance with the disclosed architecture;

FIG. 2 illustrates a perspective view showing how the personality attachment is removably or interchangeably attached to the outer surface of the mask in accordance with the disclosed architecture;

FIG. 3 illustrates a perspective view of a user wearing another embodiment of the facemask personality attachment in accordance with the disclosed architecture;

FIG. 4A illustrates a perspective view showing an embodiment of the personality attachment being attached to the rear surface of a smartphone in accordance with the disclosed architecture;

FIG. 4B illustrates a rear perspective view of the smartphone with the attached personality attachment in accordance with the disclosed architecture;

FIG. 5 illustrates a cup with an embodiment of the personality attachment removably attached to the exterior surface of the cup in accordance with the disclosed architecture;

FIG. 6 illustrates a perspective view of bags with exemplary personality attachments adhered thereon for personalization and conveying messages in accordance with the disclosed architecture;

FIG. 7 illustrates a helmet with an attached personality attachment for sending a message in accordance with the disclosed architecture; and

FIG. 8 illustrates a front view of a refrigerator with attached magnetic personality attachments of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device and method that enable a person to easily communicate a message, feeling or state of mind. There is also a long-felt need in the art for a device that enables individuals to display their beliefs and ideas. Additionally, there is a long-felt need in the art for a device that enables individuals to communicate a message non-verbally. Moreover, there is a long-felt need in the art for a device and method that can be used by introverts, shy individuals, and more to share their thoughts effectively. Further, there is a long-felt need in the art for an attachment device that is customizable and versatile so that individuals are able to express themselves and reveal their essence. Finally, there is a long-felt need in the art for attachment devices that can be adhered to any surface enabling individuals to display and communicate new ideas, beliefs, thoughts, messages, feelings, and more without ever having to speak.

The present invention, in one exemplary embodiment, is a novel customized facemask. The customized facemask is designed to protect a wearer of the facemask from pathogens and cross-contamination while providing a way to communicate a message or feeling non-verbally. The facemask comprises a pair of ear loops connected to a facemask body, the facemask body designed to cover the mouth and nose of a wearer, and a customized attachment releasably attached to an outer surface of the facemask body wherein the customized attachment has a message printed thereon to communicate non-verbally to other users. The facemask also has a PM2.5 filter for blocking pathogens.

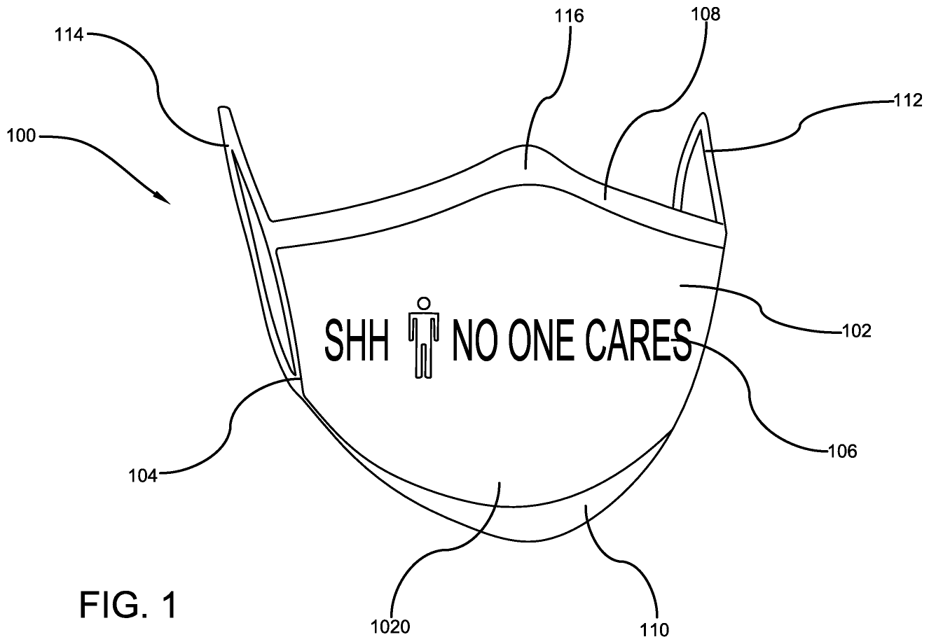

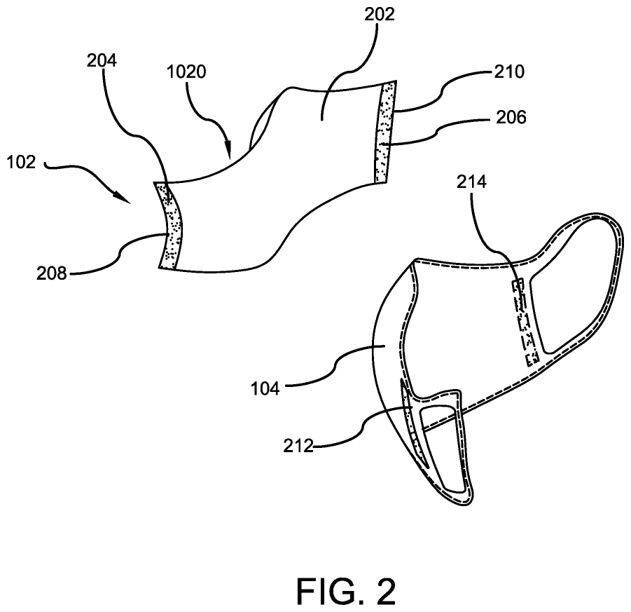

Referring initially to the drawings, FIG. 1 illustrates a perspective view of one potential embodiment of a facemask equipped with a facemask personality attachment of the present invention in accordance with the disclosed architecture. The facemask 100 has a shape and size similar to a conventional facemask for covering the mouth and nose of a wearer, providing proper protection against pathogens such as Covid-19 SARS, germs, viruses, and other microbes while visually translating a message/feeling/mood or the wearer's state of mind. More specifically, a personality attachment or second air filtration layer 102 is removably attached to an outer surface or first air filtration layer 104 of the mask 100 using a hook and loop fastener as illustrated in FIG. 2. The personality attachment or second air filtration layer 102 can be designed in any color and may have a message 106 printed on the front surface 1020 for reflecting the state of mind of the wearer. The message 106 can be 2D or 3D printed and can be in any color.

The personality attachment or second air filtration layer 102 is shaped and sized to cover a majority of the outer surface or first air filtration layer 104 extending from the top seam or edge 108 to the bottom seam or edge 110 such that the message 106 is clearly visible to others. The facemask 100 has a pair of adjustable ear loops 112, 114 for engaging to the left ear and the right ear of the wearer, respectively. The personality attachment or second air filtration layer 102 can be replaced with other attachments having different messages for reflecting the present mood and/or present state of the wearer.

The personality attachment or second air filtration layer 102 along with the facemask 100 is made from a breathable and washable material. Personality attachment or second air filtration layer 102 in particular is made from a cloth, fabric, or patch material that easily adheres to the facemask 100. In the present embodiment, the facemask 100 also has a replaceable PM2.5 filter and can be worn by individuals of all ages. It should be appreciated that the facemask personality attachment or second air filtration layer 102 enables a wearer of the mask 100 to artistically and non-verbally communicate with another while providing a second air filtration layer for filtering the air.

FIG. 2 illustrates a perspective view showing how the personality attachment or second air filtration layer 102 is removably attached to the outer surface or first air filtration layer 104 of the mask 100 in accordance with the disclosed architecture. The facemask personality attachment or second air filtration layer 102 has a message 106 on the front surface 1020 as illustrated in FIG. 1 and has a planar rear surface 202. The attachment 102 is sized to cover a majority of the outer surface or first air filtration layer 104 of the mask 100 such that the hook fasteners 204, 206 positioned along the side seams 208, 210 of the attachment 102 are removably fastened respectively to the loop fasteners 212, 214 positioned on the outer surface or first air filtration layer 104 of the mask 100. In one exemplary embodiment, the attachment 102 covers more than 80% of the area of the first air filtration layer 104. In another exemplary embodiment, the attachment 102 covers more than 90% of the area of the first air filtration layer 104.

The releasable secure attachment using the hook and loop fasteners provides a secure attachment while enabling easy removal of attachment 102 as per the preferences of a user. Attachment 102 when adhered to the facemask 100 does not slide or misplace. Further, the message printed on the front surface is clearly visible to others and helps in translating messages, feelings, and/or state of mind of the wearer.

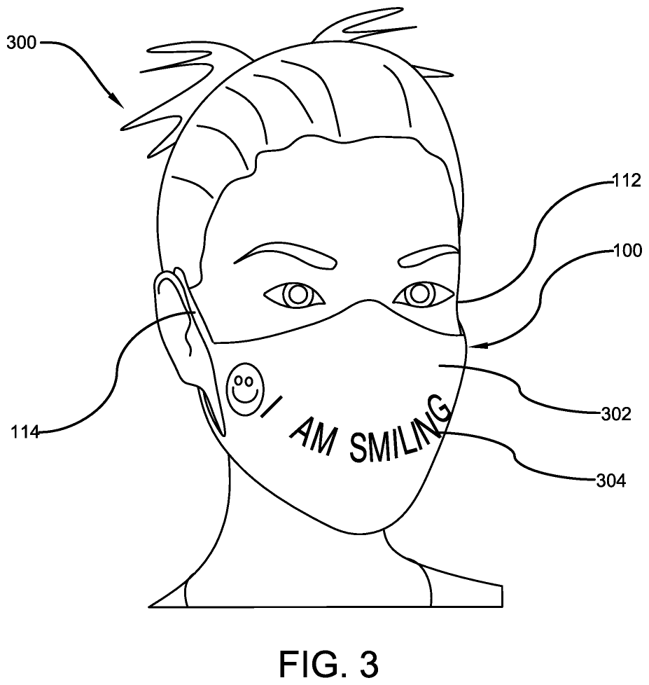

FIG. 3 illustrates a perspective view of a user wearing another embodiment of the facemask personality attachment in accordance with the disclosed architecture. In the present embodiment, a user 300 is wearing the facemask 100 with releasably attached personality attachment 302 that has a message 304 “I AM SMILING” printed thereon. The personality attachment 302 is releasably attached in a manner described in FIG. 2. It should be noted that attachment 302 not only personalizes the facemask 100 but also enables individuals to communicate non-verbally and maintain personal engagement and interaction with others without speaking.

The ear loops 112, 114 enable the easy and secure wearing of the mask 100 without any discomfort. Further, the mask 100 and the attachment 302 comfortably cover the mouth and nose of the wearer 300, thereby providing dual air filtration layers 100, 302 to protect from germs, pathogens, dust, and cross-contamination.

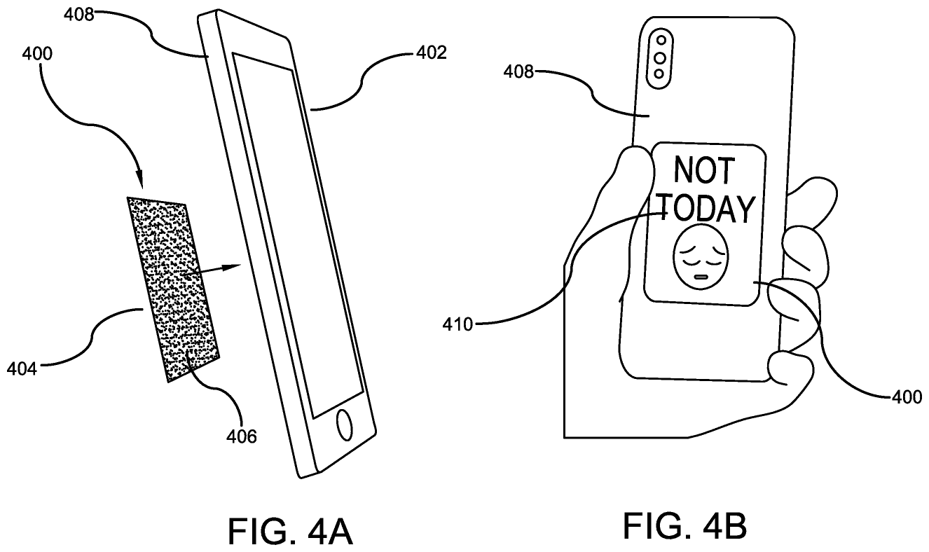

FIG. 4A illustrates a perspective view showing an embodiment of the personality attachment being attached to a rear surface of a smartphone in accordance with the disclosed architecture. The personality attachment of the present invention can be designed in various shapes, sizes, and designs to be adhered to and displayed on face masks, earrings/rings, canisters/cups, shirts, hats/caps, plastered on walls, refrigerators, office/school boards, garages, vehicles and more. In the present embodiment, the personality attachment 400 is generally rectangular and can be used for personalizing the smartphone 402 while communicating a message to others.

The personality attachment 400 has a front surface 404 having a message (shown in FIG. 4B) and a rear surface 406 having an adhesive layer. The adhesive enables the attachment 400 to removably attach to any surface such as a rear surface 408 of the smartphone 402. The personality attachment 400 is generally rectangular but can be of any shape to cover a portion of the smartphone 402.

FIG. 4B illustrates a rear perspective view of the smartphone 402 with the attached personality attachment 400 in accordance with the disclosed architecture. As illustrated, a message 410 of attachment 400 is visible and can be used as a means of communicating non-verbally. The message 410 can be used for indicating a notice or message to be conveyed by the owner of the smartphone 402. The attachment 400 can be 2D or 3D and the message can be printed in a radiant material which radiates in dark.

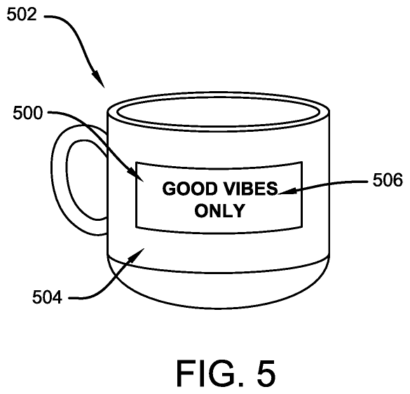

FIG. 5 illustrates a cup with an embodiment of the personality attachment removably attached to an exterior surface of the cup in accordance with the disclosed architecture. In the present embodiment, the personality attachment 500 is removably attached to the exterior surface 504 of cup 502. Attachment 500 can include a message 506, for example, such as “Good Vibes Only” or “No Bad Vibe” printed thereon wherein the message 506 can be personalized as per the preference of a user of the cup 502.

In the present embodiment, the attachment 500 is made from an insulating material like an insulating plastic that enables a user to easily hold a hot or cold cup. Further, the adhesive of the attachment can easily adhere to any material thereby preventing slippage during use.

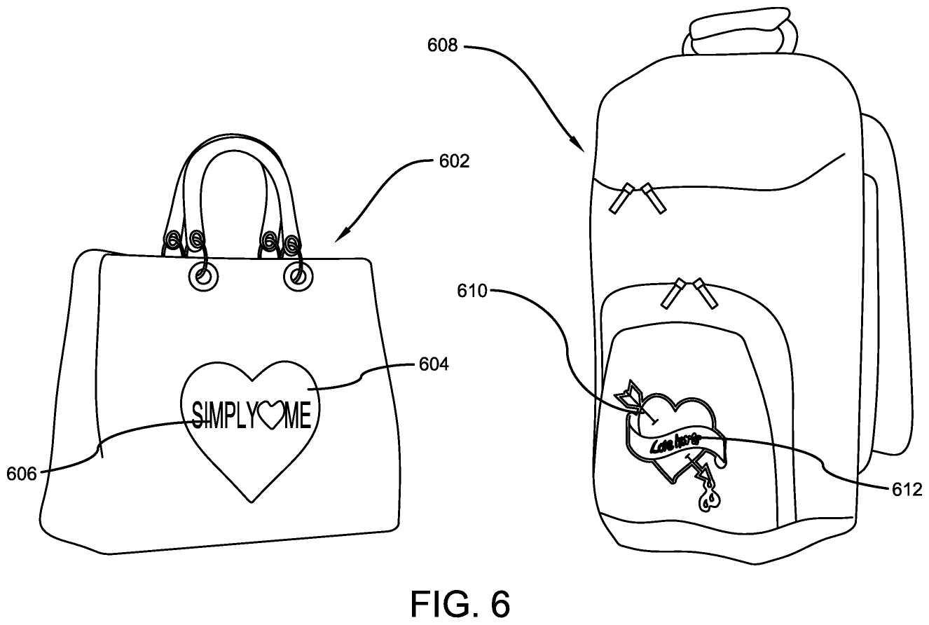

FIG. 6 illustrates a perspective view of bags with exemplary personality attachments adhered thereon for personalization and conveying messages in accordance with the disclosed architecture. The handbag 602 has an attachment 604 adhered thereon wherein the attachment 604 is in heart shape and has a customized message 606. The attachment 604 and the message 606 can be of any color and shape as per preferences of the users.

Similarly, bag 608 has an attachment 610 adhered thereon and has a customized message 612. The attachments 604, 610 are releasably attached and may use a hook and loop fastener or any other fasteners such as snap buttons or clips for attachment.

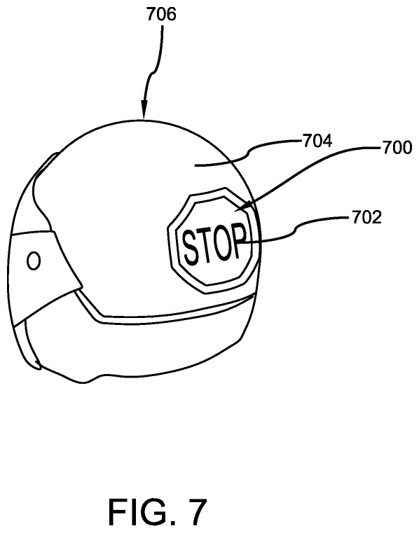

FIG.7 illustrates a helmet with an attached personality attachment for sending a message in accordance with the disclosed architecture. As illustrated, the personality attachment 700 has a “STOP” message 702 that can be used as a signal to other riders and is adhered on back portion 704 of the helmet 706.

The attachment 700 is in the form of an electroluminescent or photoluminescent decal, is super bright and adds extra security. High temperature, water and humidity do not influence the stickiness of the attachment 700.

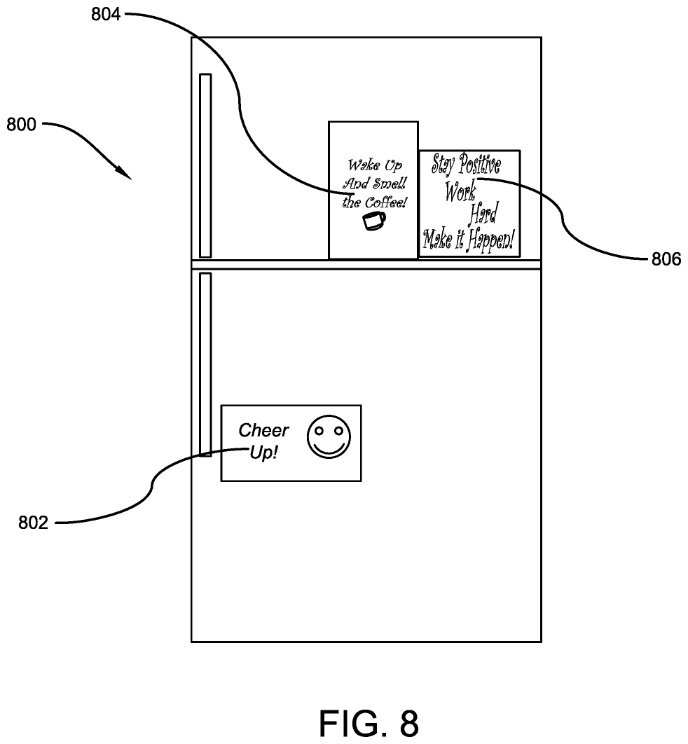

FIG. 8 illustrates a front view of a refrigerator with attached magnetic personality attachments of the present invention in accordance with the disclosed architecture. As illustrated, a plurality of customized magnetic attachments 802, 804, 806 are removably attached to the refrigerator 800. In the present embodiment, the attachments 802, 804, 806 have a flexible magnetic surface, however an adhesive can also be used for removably attaching the attachments to the refrigerator.

It should be appreciated that the personality attachments of various embodiments of the present invention do not permanently attach to a surface and therefore, enables users to use an endless array of interchangeable designs to accommodate dynamic thoughts and feelings. All the personality attachments are machine washable and can come in themed collections of 10, 15, 20, 50 or more attachments.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “personality attachment”, “attachment”, “magnetic attachment”, “magnetic garment”, and “facemask personality attachment” are interchangeable and refer to the personality attachment or second air filtration layer 102, 302, 400, 500, 604, 700, 802, 804, 806 of the present invention.

Notwithstanding the foregoing, the personality attachment or second air filtration layer 102, 302, 400, 500, 604, 700, 802, 804, 806 of the present invention can be of any suitable size and configuration as is known in the art without affecting the overall concept of the invention, provided that it accomplishes the above-stated objectives. One of ordinary skill in the art will appreciate that the personality attachment or second air filtration layer 102, 302, 400, 500, 604, 700, 802, 804, 806 as shown in the FIGS. are for illustrative purposes only, and that many other sizes and shapes of the personality attachment or second air filtration layer 102, 302, 400, 500, 604, 700, 802, 804, 806 are well within the scope of the present disclosure. Although the dimensions of the personality attachment or second air filtration layer 102, 302, 400, 500, 604, 700, 802, 804, 806 are important design parameters for user convenience, the personality attachment or second air filtration layer 102, 302, 400, 500, 604, 700, 802, 804, 806 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A facemask covering the mouth and nose of a wearer comprising:
a facemask having a first air filtration layer;
a first personality attachment removably attached to an outer surface of said facemask having a second air filtration layer;
a first hook and loop fastener for removably attaching said first personality attachment to said outer surface of said facemask;
wherein said first personality attachment conveys a first message representing a first mood of the wearer of said facemask; and
further wherein said first mood of the wearer is one state of mind of the wearer.

2. The facemask covering of claim 1 further comprising a second personality attachment removably attached to said outer surface of said facemask and a second hook and loop fastener for removably attaching said second personality attachment to said facemask and replacing said first personality attachment, wherein said second personality attachment conveys a second message representing a second mood of the wearer of said facemask, and further wherein said second mood of the wearer is another state of mind of the wearer.

3. The facemask covering of claim 2, wherein said facemask further comprising a PM2.5 filter for filtering pathogens from a Covid-19 SARS virus.

4. The facemask covering of claim 3, wherein said first personality attachment and said second personality attachment are 3D.

5. The facemask covering of claim 4, wherein said facemask having a left ear adjustable loop for engaging a left ear and a right ear adjustable loop for engaging a right ear.

6. The facemask covering of claim 5, wherein said first personality attachment and said second personality attachment extend from a top edge of said facemask to a bottom edge of said facemask.

7. The facemask covering of claim 1, wherein said first air filtration layer includes a first area and said second air filtration layer includes a second area, and further wherein said second area covers a majority of said first area.

8. The facemask covering of claim 1, wherein said first air filtration layer includes a first area and said second air filtration layer includes a second area, and further wherein said second area covers more than 80% of said first area.

9. The facemask covering of claim 1, wherein said first air filtration layer includes a first area and said second air filtration layer includes a second area, and further wherein said second area covers more than 90% of said first area.

10. A facemask covering the mouth and nose of a wearer comprising:
a facemask having a first air filtration layer;
a first personality attachment removably attached to an outer surface of said facemask having a second air filtration layer;
a first hook and loop fastener for removably attaching said first personality attachment to said outer surface of said facemask;
wherein said first personality attachment conveys a first message representing a first mood of the wearer of said facemask;
wherein said first mood of the wearer is one state of mind of the wearer;
wherein said first air filtration layer includes a first area and said second air filtration layer includes a second area;
wherein said second area covers more than 80% of said first area;
a second personality attachment removably attached to said outer surface of said facemask;
a second hook and loop fastener for removably attaching said second personality attachment to said facemask and replacing said first personality attachment;
wherein said second personality attachment conveys a second message representing a second mood of the wearer of said facemask; and
further wherein said second mood of the wearer is another state of mind of the wearer.

11. The facemask covering of claim 10, wherein said facemask further comprising a PM2.5 filter for filtering pathogens from a Covid-19 SARS virus.

12. The facemask covering of claim 11, wherein said first personality attachment and said second personality attachment are 3D.

13. The facemask covering of claim 12, wherein said facemask having a left ear adjustable loop for engaging a left ear and a right ear adjustable loop for engaging a right ear.

14. The facemask covering of claim 13, wherein said first personality attachment and said second personality attachment extend from a top edge of said facemask to a bottom edge of said facemask.

15. The facemask covering of claim 14, wherein said second area covers more than 90% of said first area.

16. A facemask covering the mouth and nose of a wearer comprising:
a facemask having a first air filtration layer;
a first personality attachment removably attached to an outer surface of said facemask having a second air filtration layer;
a first hook and loop fastener for removably attaching said first personality attachment to said outer surface of said facemask;
wherein said first personality attachment conveys a first message representing a first mood of the wearer of said facemask;
wherein said first mood of the wearer is one state of mind of the wearer;
wherein said first air filtration layer includes a first area and said second air filtration layer includes a second area;
wherein said second area covers more than 80% of said first area;
a second personality attachment removably attached to said outer surface of said facemask;
a second hook and loop fastener for removably attaching said second personality attachment to said facemask and replacing said first personality attachment;
wherein said second personality attachment conveys a second message representing a second mood of the wearer of said facemask;
wherein said second mood of the wearer is another state of mind of the wearer; and
further wherein said first personality attachment and said second personality attachment extend from a top edge of said facemask to a bottom edge of said facemask.

17. The facemask covering of claim 16, wherein said facemask further comprising a PM2.5 filter for filtering pathogens from a Covid-19 SARS virus.

18. The facemask covering of claim 17, wherein said first personality attachment and said second personality attachment are 3D.

19. The facemask covering of claim 18, wherein said facemask having a left ear adjustable loop for engaging a left ear and a right ear adjustable loop for engaging a right ear.

20. The facemask covering of claim 19, wherein said second area covers more than 90% of said first area.
